(19) United States
(12) Patent Application Publication
(10) Pub. No.: US 2024/0230168 A1
(43) Pub. Date: Jul. 11, 2024

(54) CRYOGENIC REFRIGERATOR OF STIRLING TYPE WITH DUAL-PISTON COMPRESSOR AND CONCEALED EXPANDER

(71) Applicant: CRYO TECH LTD., Ein Harod (IL)

(72) Inventor: Alexander Veprik, Kiriyat Motzkin (IL)

(73) Assignee: CRYO TECH LTD., Ein Harod (IL)

(21) Appl. No.: 18/096,010

(22) Filed: Jan. 11, 2023

(51) Int. Cl. F25B 9/14; F25B 31/02

(52) U.S. Cl. CPC F25B 9/14; F25B 31/023; F25B 2309/001; F25B 2400/073; F25B 2700/21; G01J 5/061

(57) ABSTRACT

A Stirling type cryogenic refrigerator device includes a dual-piston compressor and a pneumatic expander, wherein some of the pneumatic expander is concealed within the body of the dual-piston compressor.

### FIELD OF THE INVENTION

The present invention relates to cryogenic refrigeration devices. More particularly, the present invention relates to a compact cryogenic device of Stirling type featuring a dual piston compressor and orthogonally concealed expander.

### BACKGROUND OF THE INVENTION

The second law of thermodynamics states that heat spontaneously flows from warmer objects to colder objects. The direction of heat flow may, however, be reversed to pump heat from an object at a lower temperature than its surroundings by applying external work. This principle is employed in cooling devices such as heat pumps (e.g., refrigerators), where the heat is absorbed at a cold location and rejected to a warmer environment. In the case where the cold location is cooled to cryogenic temperatures, such a cooling device is typically referred to as a “cryocooler”.

For example, a cryocooler may be used to maintain a focal plane array of an infrared imager at a cryogenic temperature in order to attenuate intrinsic thermally induced noise, thus enabling long working ranges, short integration times and high spatial and/or temperature resolution. A cooling device for such imaging applications must often be sufficiently cost effective, small (so as to fit inside an infrared imager or other electro-optical device in which the detector is incorporated) and consume low electrical power.

Efficient use of space for such cryocooler applications is a known problem in the art.

FIG. 1 schematically shows a split Stirling type cryogenic cooler, as is known in the art. A split Stirling type cryogenic cooler typically includes a compressor unit 1, an expansion unit 2, a transfer line 3, and a distal cold end 4 of the expansion unit.

A split type cryogenic cooler typically operates on the basis of a closed Stirling thermodynamic cycle, during which a gaseous working agent (e.g., helium, nitrogen, or another suitable, usually inert, gas) is cyclically compressed (e.g., by a piston) in a compression chamber of compressor unit 1 and then is allowed to cyclically expand within an expansion chamber of expansion unit 2 while performing mechanical work on a motion of displacer (e.g., expansion piston), thus resulting in a favorable cooling effect at the cold end 4 of the expansion unit. Cold end 4 may be used for thermal interfacing with an object to be cooled, such as an infrared detector.

A piston of compression unit 1 is typically driven by an electromagnetic actuator (e.g., a linear actuator of “moving coil”, “moving magnet” or “moving iron” type) and configured to cyclically compress and decompress the gaseous working agent in the compression chamber of the compressor unit. Typically, a flexible and configurable transfer line 3 (e.g., any conduit that is capable of enabling a flow of the working agent) connects the compression chamber of compressor unit 1 to an expansion chamber of expansion unit 2. A reciprocating expansion piston (e.g., referred to as a displacer), containing a porous regenerative heat exchanger (e.g., referred to as a regenerator), is moved back and forth within the expansion unit to transfer (e.g. pump) heat from the expansion chamber to a warm chamber at a base of the expansion unit, typically at the opposite end of the expansion unit from the expansion chamber. The displacer may be spring assisted and resonantly driven by a cyclic pressure wave generated by the compressor piston. The differential piston may be attached to the warm side of the displacer and may generate a driving force; in this case, the driving differential force is in phase with the pressure wave. The driving force may also be generated by the drag resulting from the cyclic flow of the working agent through the regenerator material; in this case, the driving force is in phase with the relative velocity of the working agent and displacer.

The regenerator material may absorb heat from the gaseous working agent during the compression stage and release the heat to the working agent during the expansion stage of the Stirling cycle. The transferred heat is typically rejected to the environment from the warm chamber during a compression stage of the thermodynamic cycle. The expansion work is typically recovered and further used to assist actuation of the compression piston. Recovery of expansion work is a typical feature of Stirling cryogenic refrigeration devices and contributes to their high performance.

Split Stirling cryocoolers are often used in cryogenically cooled infrared imagers, such as compact hand-held and gyro-stabilized infrared imagers, where compactness is of primary concern. Split configuration may allow compact packaging of the cryocooler for such applications. The maximum dimension of such imagers may be governed by the size of the optical chain including the axial size of an Integrated Dewar Detector Assembly (IDDA) and collinearly placed infrared optics.

FIG. 2 schematically shows an integrated Dewar detector assembly (IDDA), as is known in the art. The components in the optical direction are shown, including expander 2 having cold finger 21, rear cover 22, substrate 23 carrying a focal plane array (FPA) 231, cold shield 24, cold filter 25, and evacuated envelope 26 sealed with infrared window 27 providing for the vacuum isolation of the cold parts. The cold shield may be externally gold plated to reflect heat away from the cold parts. The FPA may be integrated with a Readout Integrated Circuit (ROIC). Cold shield 24, and cold filter 25 may be mounted directly upon a cold tip of cold finger 21. Infrared focusing optics (not shown) may be mounted in line with the infrared window 27. The distance between the distal side of the rear cover 22 to the infrared window 27 defines the length in the optical direction of the IDDA. This dimension defines the critical size of the infrared device.

FIG. 3 schematically shows side-by-side packaging of an IDDA and compressor unit, as is known in the art. Compressor unit 1, and expansion unit 2 integrated with Dewar detector assembly 200 are located side-by-side and interconnected by the transfer line 3. They may be supported by a dedicated frame serving as an optical bench or directly by the imager enclosure (not shown). In this manner, the compressor (which may include the most bulky and massive components of the refrigerator, and which requires connection to a source of electrical power) may be located remotely from the object to be cooled. This may enable flexibility in the design of a component that requires cooling, however the transfer line may be a point of weakness/vulnerability in the system, adds mechanical complexity, is prone to mishandling, and can result in parasitic pneumatic losses.

Another disadvantage is that unused void volumes (VV) are seen primarily between the cylindrical bodies of compressor 1 and IDDA 200 and partially outside of the cylindrical bodies 1 and 200. The bottom of FIG. 3 shows a plan view of the cylindrical bodies 1 and 200 and the void volumes therebetween. These void volumes may represent under utilised space of the total cryogenic system, which for small size imaging applications on movable platforms. (e.g., infrared imagers on aerial platforms such as drones) can result in increased size and weight. This may present an issue for their use on compact platforms.

FIG. 4 schematically shows an inline integral Stirling type cryogenic cooler, as is known in the art. The compressor unit 1 and IDDA 200 are integrated collinearly. This topology removes the need for the transfer line and simplifies design, but also results in an extended total length in the optical direction due to the added length of the compressor. There may also be some void volume VV remaining around cylindrical parts of the evacuated Dewar detector assembly. These factors may limit the applicability of such a topology for compact imaging applications.

FIG. 5 schematically shows a T-type integral Stirling cryogenic cooler, as is known in the art. The compressor unit 1 and IDDA 200 are integrated orthogonally in a “T” type shape. The T-type concept is typically employed for low vibration dual-piston compressors comprised of two identical sub-compressors which are placed collinearly upon a common base part, share a common current and compression space and are driven oppositely, thus counterbalancing each other and, therefore, resulting in an in-source cancelling vibration export. In the T-type concept, the expander unit is placed orthogonally to the compressor axis, sharing its base part and having pneumatic communication with the shared compression space, eliminating the need for the transfer line as in FIG. 4. This topology results in a shorter total length in the optical direction (e.g., as compared to in FIG. 4) comprised of the diameter of compressor 1 and the length of IDDA 200 (e.g., the length of the expander and Dewar detector assembly). The total length in the optical direction due to the added length of the compressor diameter may still be unacceptable for some applications, such as aerial gyrostabilized applications. Some void volume VV may also remain around the cylindrical parts of the evacuated Dewar.

A need exists for a cryocooler configuration which further reduces the total length in the optical direction and reduces unused volume.

### SUMMARY OF THE INVENTION

There is thus provided, in accordance with an embodiment of the invention, a Stirling type cryogenic refrigerator device which includes: a dual-piston compressor and a pneumatic expander, wherein some of the pneumatic expander is concealed within the body of the dual-piston compressor.

According to some embodiments, most of the pneumatic expander is concealed within the body of the dual-piston compressor.

According to some embodiments, the dual-piston compressor includes two sub-compressor assemblies, each having a compression space in a pneumatic communication with the warm space of the pneumatic expander.

According to some embodiments, each of the two sub-compressor assemblies of the dual-piston compressor includes a piston, wherein the pistons of the two sub-compressor assemblies are configured to be driven collinearly with respect to a first axis.

According to some embodiments, the pistons of the two sub-compressor assemblies are configured to be driven oppositely.

According to some embodiments, the pistons of the two sub-compressor assemblies are configured to be driven by an electromagnetic actuator.

According to some embodiments, the electromagnetic actuator is one of a moving coil type, a moving magnet type, or a moving iron type.

According to some embodiments, the pneumatic expander is located within a bore in a housing of the dual-piston compressor, the bore extending along a second axis which is orthogonal to the first axis.

According to some embodiments, the pneumatic expander includes a spring assisted displacer configured to be driven within the bore collinearly with the second axis by a pressure wave generated by the dual-piston compressor assembly.

According to some embodiments, the spring is a magnetic spring.

According to some embodiments, the magnetic spring includes an axially and oppositely polarized coaxial width centered magnetic rings.

According to some embodiments, the pneumatic expander includes a regenerator material formed of a cylindrical bundle of synthetic filaments parallel to the second axis.

According to some embodiments, the Stirling type cryogenic refrigerator device includes a gaseous working agent.

According to one or more embodiments, there is provided a system which includes: a Stirling type cryogenic refrigerator device including: a dual-piston compressor and a pneumatic expander, wherein some of the pneumatic expander is concealed within the body of the dual-piston compressor; and an imaging system comprising a focal plane array, wherein the focal plane array is configured to be maintained at a predefined temperature by a thermal connection to the Stirling type cryogenic refrigerator device.

According to some embodiments, an optical path of the imaging system is orthogonal to a driving axis of the dual-piston compressor and parallel to a driving axis of the pneumatic expander.

According to some embodiments, the imaging system is a thermal imaging system.

According to some embodiments, the focal plane array is housed in an integrated Dewar detector assembly (IDDA).

According to some embodiments, the system is mounted on a movable platform.

According to one or more embodiments, there is provided a housing for a Stirling type cryogenic refrigerator, the housing comprising a first bore along a first axis, and a second bore intersecting the first bore along a second axis orthogonal to the first axis, wherein each end of the first bore is configured to receive a sub-compressor assembly of a dual-piston compressor assembly of the Stirling type cryogenic refrigerator, and wherein the second bore is configured to receive a pneumatic expander of the Stirling type cryogenic refrigerator.

According to some embodiments, the second bore is deep enough to accommodate most of the length of the pneumatic expander.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 schematically shows a split Stirling type cryogenic cooler (prior art);

FIG. 2 schematically shows an integrated Dewar detector assembly (IDDA) (prior art);

FIG. 3 schematically shows side-by-side packaging of an IDDA and compressor unit (prior art);

FIG. 4 schematically shows an inline integral Stirling type cryogenic cooler (prior art):

FIG. 5 schematically shows a T-type integral Stirling cryogenic cooler (prior art);

FIG. 6A shows a 3D model of a housing for a Stirling type cryogenic refrigerator, according to some embodiments of the invention;

FIG. 6B shows a 3D model cross section of a housing for a Stirling type cryogenic refrigerator, according to some embodiments of the invention;

FIG. 6C shows a schematic cross section of a housing for a Stirling type cryogenic refrigerator, according to some embodiments of the invention;

FIG. 7A shows a 3D model cross section of a stator, according to some embodiments of the invention;

FIG. 7B shows a schematic cross section of a stator, according to some embodiments of the invention;

FIG. 8A shows a 3D model cross section of a mover, according to some embodiments of the invention;

FIG. 8B shows a schematic cross section of a mover, according to some embodiments of the invention;

FIG. 9A shows 3D model cross section of a linear moving iron actuator, according to some embodiments;

FIG. 9B shows a schematic cross section of a linear moving iron actuator, according to some embodiments;

FIG. 10A shows a 3D model cross section of a moving cylinder assembly, according to some embodiments of the invention;

FIG. 10B shows a schematic cross section of a moving cylinder assembly, according to some embodiments of the invention;

FIG. 11A shows a 3D model of compressor base assembly, according to some embodiments of the invention;

FIG. 11B shows a 3D model cross section of a compressor base assembly, according to some embodiments of the invention;

FIG. 11C shows a schematic cross section of a compressor base assembly, according to some embodiments of the invention;

FIG. 12A shows a 3D model of a cold finger, according to some embodiments of the invention;

FIG. 12B shows a 3D model cross section of a cold finger, according to some embodiments of the invention;

FIG. 12C shows a schematic cross section of a cold finger, according to some embodiments of the invention;

FIG. 13A shows a 3D model of a displacer assembly, according to some embodiments of the invention;

FIG. 13B shows a 3D model cross section of a displacer assembly, according to some embodiments of the invention;

FIG. 13C shows a schematic cross section of a displacer assembly, according to some embodiments of the invention;

FIG. 13D shows a 3D model cross section of a regenerator material, according to some embodiments of the invention;

FIG. 13E shows a 3D model cross section of a regenerator material, according to some embodiments of the invention;

FIG. 14A shows a 3D model of an expander assembly, according to some embodiments of the invention;

FIG. 14B shows a 3D model cross section of an expander assembly, according to some embodiments of the invention;

FIG. 14C shows a schematic cross section of an expander assembly, according to some embodiments of the invention;

FIG. 15A shows a 3D model of a Stirling type cryogenic refrigerator, according to some embodiments of the invention;

FIG. 15B shows a 3D model cross section of a Stirling type cryogenic refrigerator, according to some embodiments of the invention:

FIG. 15C shows a schematic cross section of a Stirling type cryogenic refrigerator, according to some embodiments of the invention;

FIG. 15D shows a close up schematic cross section of a Stirling type cryogenic refrigerator, according to some embodiments of the invention; and

FIG. 16 schematically shows a Dewar detector assembly integrated with a Stirling type cryogenic refrigerator, according to some embodiments of the invention

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining.” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

In accordance with an embodiment of the present invention there is thus provided a novel Stirling type cryogenic refrigerator. The Stirling type cryogenic refrigerator may be constructed of two identical sub-compressors and an expander mounted within a common housing, whereupon the sub-compressors are mounted collinearly, and the expander is mounted orthogonally to the compressor's axis concealed within a radial bore provided in the common housing. The bore may be deep enough to accommodate most, if not all, of the length of the pneumatic expander. Conduits are provided for pneumatic communication of the compression spaces of the sub-compressors and a warm chamber of the expander.

According to some embodiments, some of the pneumatic expander is concealed within the body of the dual-piston compressor, for example 50% or less of the length of the pneumatic expander is concealed within the body of the dual-piston compressor. It will be understood that if more than 50% of the length of the pneumatic expander is concealed within the body of the dual-piston compressor then at least some of the length of the pneumatic expander is concealed within the body of the dual-piston compressor. In some embodiments, most of the pneumatic expander is concealed within the body of the dual-piston compressor, for example more than 50% of the length of the pneumatic expander is concealed within the body of the dual-piston compressor, such as 70%, 80%, 90% or 100% of the length of the pneumatic expander. The body of the dual-piston compressor (e.g. a common housing of the compressor and expander assemblies) may have a bore deep enough to accommodate most of the length (e.g. up to the full length) of the pneumatic expander.

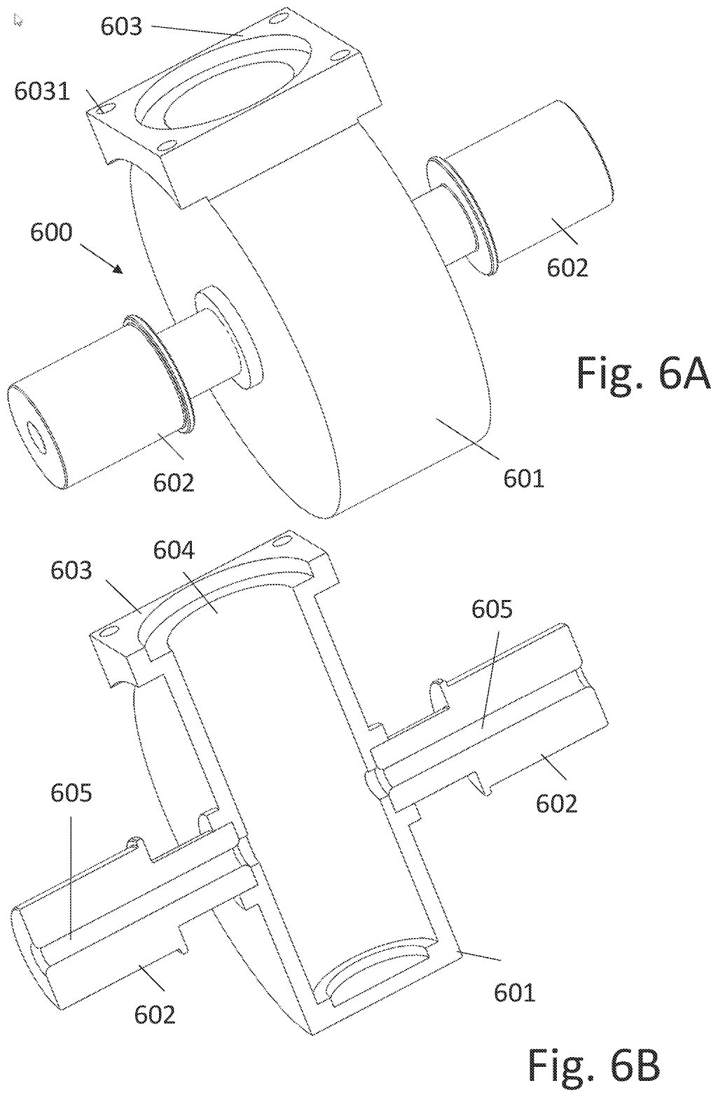

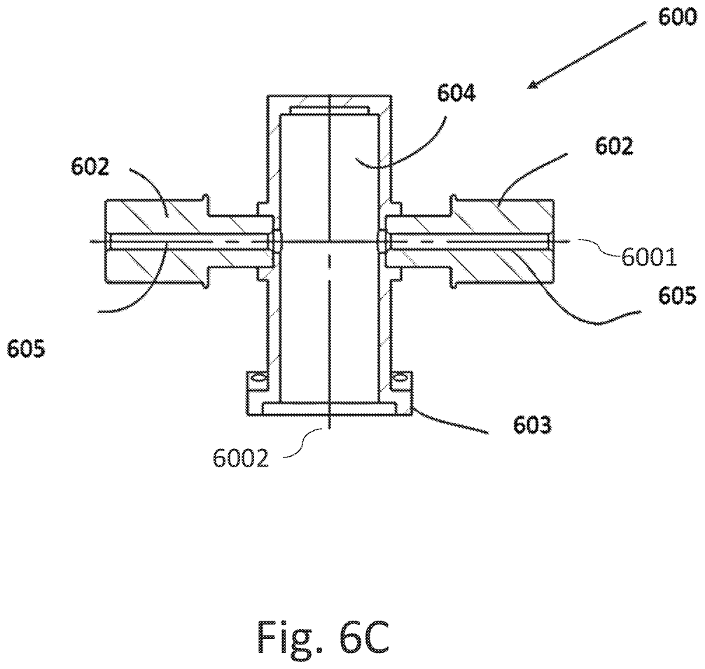

FIGS. 6A, 6B, and 6C show a 3D model and cross sections of a housing 600 for a Stirling type cryogenic refrigerator, according to some embodiments of the invention. Housing 600 may be a common base part for a compressor unit and expander unit of a Stirling type cryogenic refrigerator.

Housing 600 may include a cylindrical central part 601 extending coaxially from which may be two cylindrical extruded bosses 602 and radial connection flange 603 with threaded holes 6031. Threaded holes 6031 may be provided for anchoring a cover of a sub-compressor and/or a cold finger base.

Housing 600 may include a first bore 605 along a first axis 6001, and a second bore 604 intersecting the first bore along a second axis 6002 orthogonal to the first axis.

The first bore 605 may be defined by two conduits provided within the cylindrical extruded bosses 602 extending into the second bore 604, thereby allowing pneumatic communication between the first and second bores.

The second bore 604 may be a radial bore cut/extruded centrally with respect to the connection flange 603. Provision may be made in the central part 601 of housing 600 for a fill/purge valve (not shown).

Each end of the first bore 605 (e.g., conduits provided within the cylindrical extruded bosses 602) may be configured to receive a sub-compressor assembly of a Stirling type cryogenic refrigerator. The second bore 604 may be configured to receive a pneumatic expander of a Stirling type cryogenic refrigerator.

A Stirling type cryogenic refrigerator in accordance with some embodiments of the invention may include: housing 600 (e.g., a housing including a first bore along a first axis, and a second bore intersecting the first bore along a second axis orthogonal to the first axis); a dual-piston compressor assembly including two sub-compressor assemblies, each sub-compressor-assembly including a compression space in pneumatic communication with a respective end of the first bore, and a piston configured to be driven collinearly with the first axis within the compression space; and a pneumatic expander collinear with the second axis and located inside the second bore, the pneumatic expander including a cold finger and a displacer, the displacer including a regenerator material.

In some embodiments, the piston of each sub-compressor assembly is configured to be driven by an electromagnetic actuator. The electromagnetic actuator may be a linear electromagnetic actuator. The electromagnetic actuator may be one of a moving coil type, a moving magnet type, and/or a moving iron type.

In some embodiments, the sub-compressors are of a moving cylinder type actuated by moving iron drivers. The moving iron actuator may include a stator and a mover.

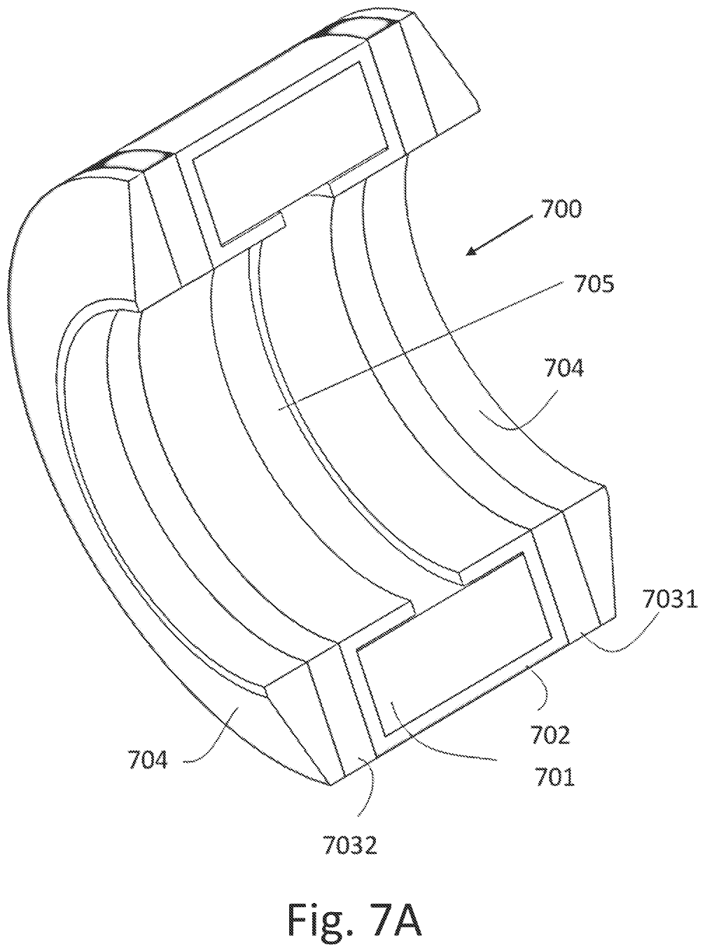

FIGS. 7A and 7B show 3D model and schematic cross sections, respectively, of a stator 700, according to some embodiments of the invention. Stator 700 may include a tubular driving coil 701. In some embodiments, tubular driving coil 701 is of the edgewise type. Driving coil 701 may be formed, for example, of a helically coiled enameled copper strip.

Stator 700 may include a plurality of magnetically soft ferromagnetic parts having high saturation polarization of and low coercivity force, forming a back iron 702. Example materials include cobalt-iron (CoFe) alloy such as VACOFLUX® and VACODUR® alloys commercially available from VACUUMSCHMELZE GmbH & Co. KG. Back iron 702 may enclose tubular driving coil 701.

Stator 700 may include a plurality of axially magnetized and collinear magnet rings adjacent to the side faces of the back iron. For example, stator 700 may include permanent magnet rings 7031 and 7032 which may be axially and oppositely magnetized. The material from which the magnet rings are made may be based on, for example, sintered neodymium-iron-boron powder having high energy density, such as VACODYM® magnets commercially available from VACUUMSCHMELZE GmbH & Co. KG.

Stator 700 may include collinear tubular side poles 704 adjacent to the side faces of magnet rings 7031 and 7032. Side poles 704 may be made of the same material as the components of the back iron assembly. An axial air gap 705 may exist in back iron 702, which may minimize parasitic infringement into the space and focus the magnet field in the proper locations.

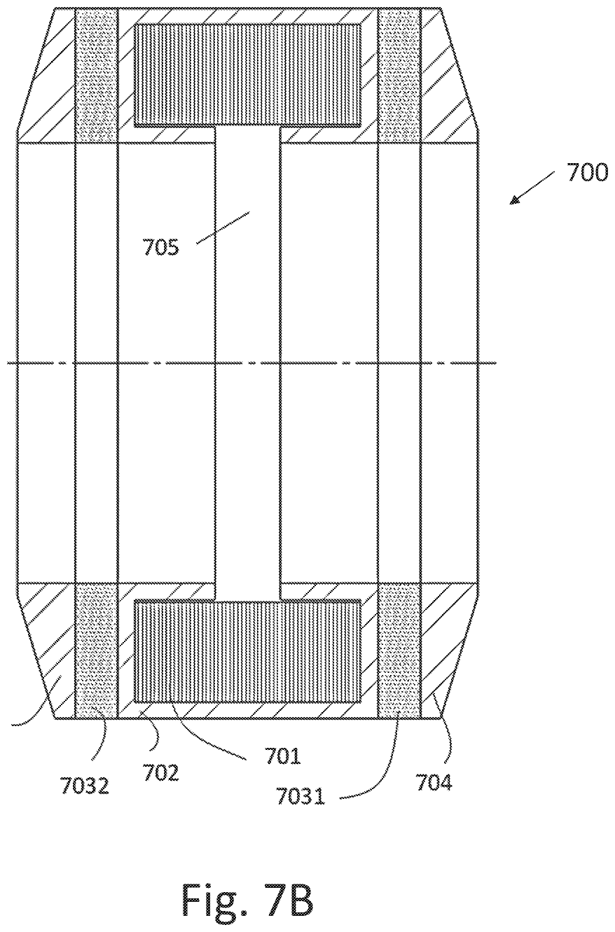

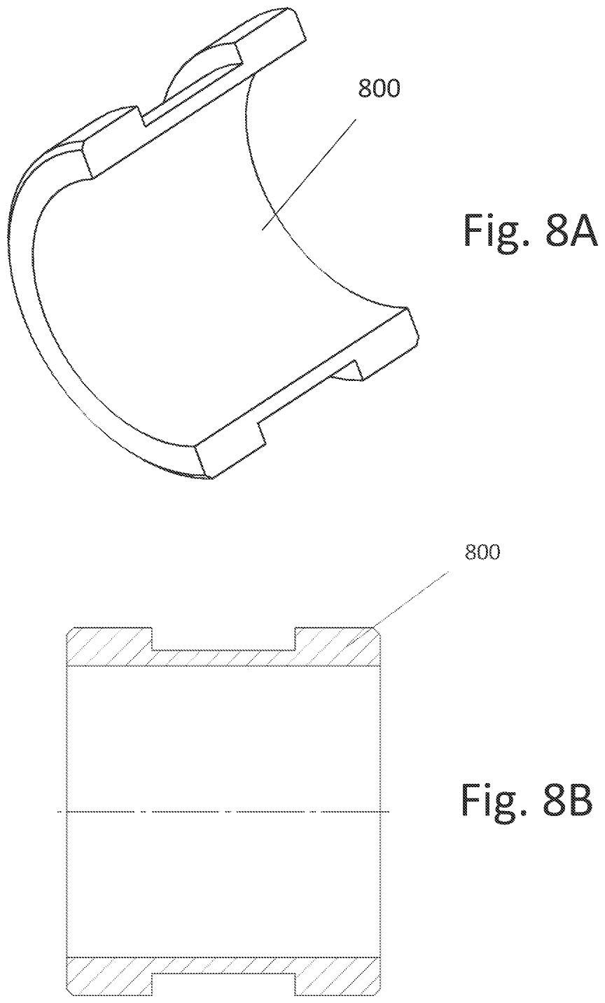

FIGS. 8A and 8B show 3D model and schematic cross sections, respectively, of a mover 800, according to some embodiments of the invention. Mover 800 may be a toothed tubular mover. Mover 800 may be made of a magnetically soft ferromagnetic material, such as the same material as the components of the back iron assembly.

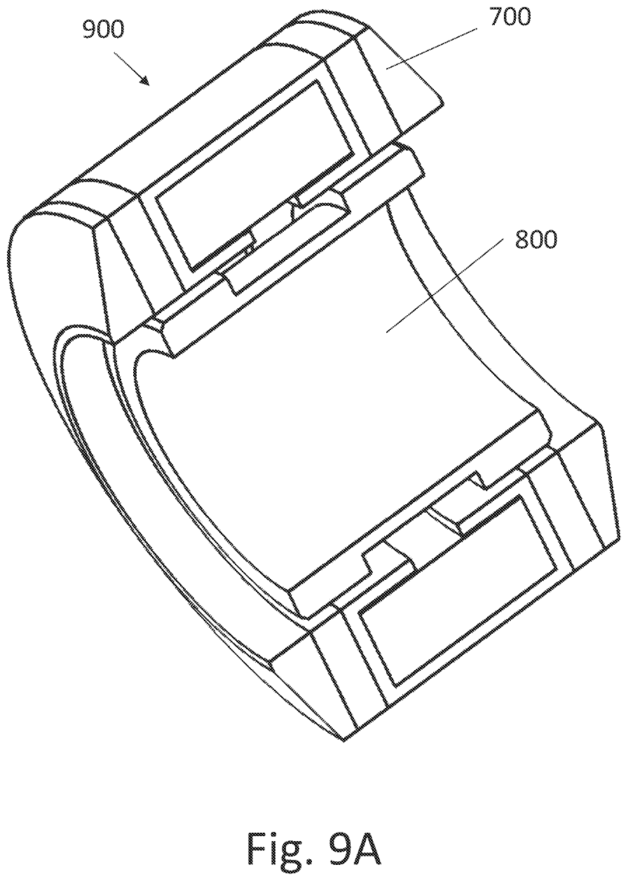

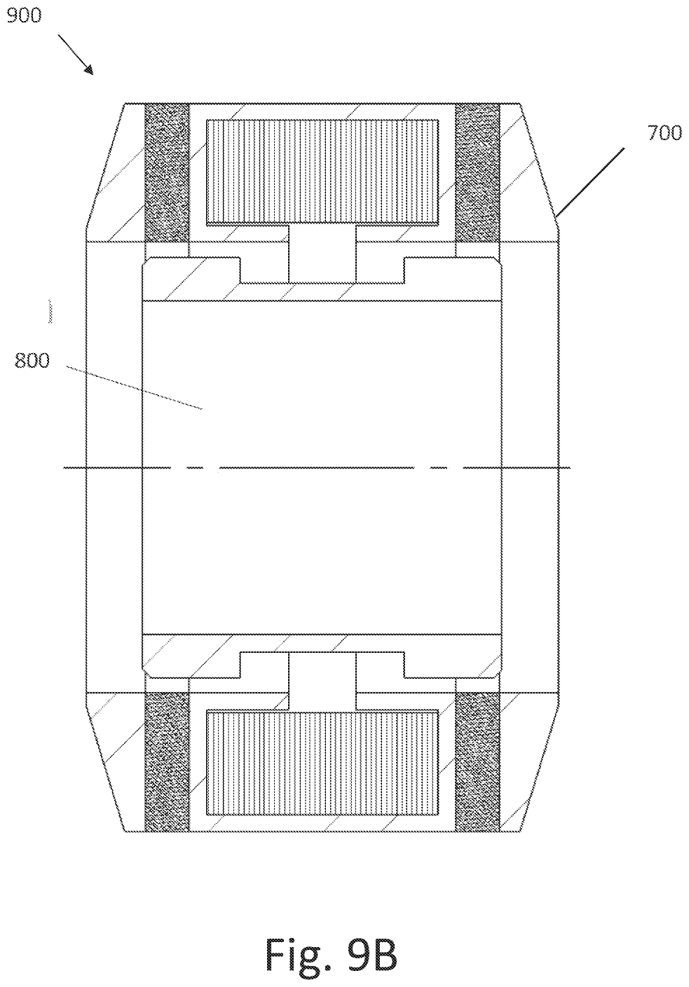

FIGS. 9A and 9B show 3D model and schematic cross sections, respectively, of a linear moving iron actuator 900, according to some embodiments of the invention. Linear moving iron actuator 900 includes stator 700 (of FIGS. 7A and 7B) and mover 800 (of FIGS. 8A and 8B) which are placed coaxially and width centered.

With reference to FIGS. 7A-B, 8A-B, and 9A-B, the magnetic fields generated by the permanent magnet rings 7031, 7032 and driving coil 701 infringe into the stator interior and interact with tubular toothed mover 800, thus forming moving iron electromagnetic actuator 900. When no electric current is present in the driving coil, the magnetic fields generated by the permanent magnets permeate into the stator interior and is attracted by the ferromagnetic mover, thus producing its magnetizing resulting in attraction of its poles to the poles of the stator. In the central width position, because of the symmetry, these attraction forces are equal and directed oppositely thus resulting in zero net force exerted upon the mover. Any axial displacement of the mover from its central position results in breaking the said conditions of symmetry in such a manner that the mover tooth moving away from the center will be attracted back more than the tooth which is approaching the center. This results in a magnet spring restoring force applied to the mover and aimed to the center of the actuator, thus the central equilibrium position is stable. When an alternating electric current flows in the driving coil, additional magnetic fields are generated, breaking the conditions of initial equilibrium; and creating a non-zero net force applied to the mover. The magnitude and direction of this force will depend on the magnitude and direction of the applied current.

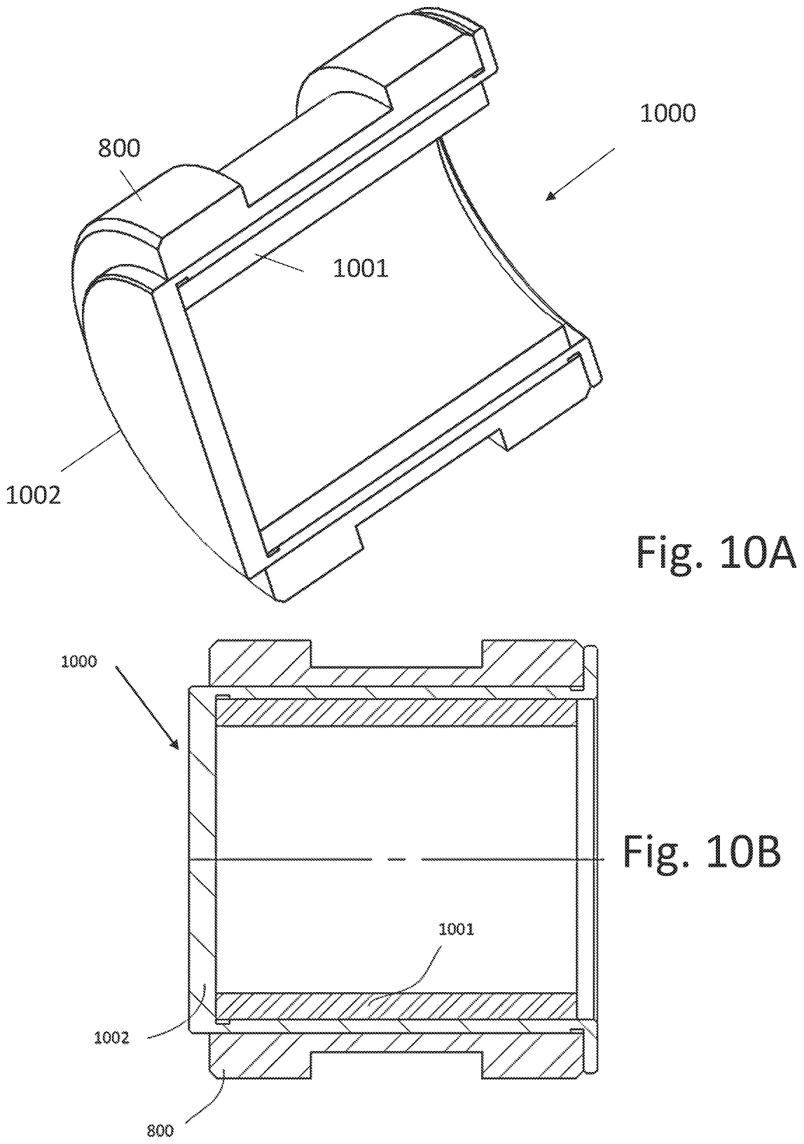

FIGS. 10A and 10B show 3D model and schematic cross sections, respectively, of a moving cylinder assembly 1000, according to some embodiments of the invention. Moving cylinder assembly 1000 may include tubular cylinder liner 1001, tubular nonmagnetic capped cylinder 1002 and mover 800. All three coaxial components 1001, 1002, and 800 may be matched with 0.01 mm radial gaps and may be connected by adhesives. The adhesives may be low outgassing adhesives, such as Loctite 638 or similar.

Cylinder liners 1001 may be made of high-speed tool steel, such as M42 or the like per ASTM A600-92a (2016).

Tubular nonmagnetic capped cylinder 1002 may be made of a diamagnetic, low electrically conductive material such as titanium alloy or stainless steel.

Moving cylinder assemblies 1000 may act as compression pistons in respective sub-compressor units.

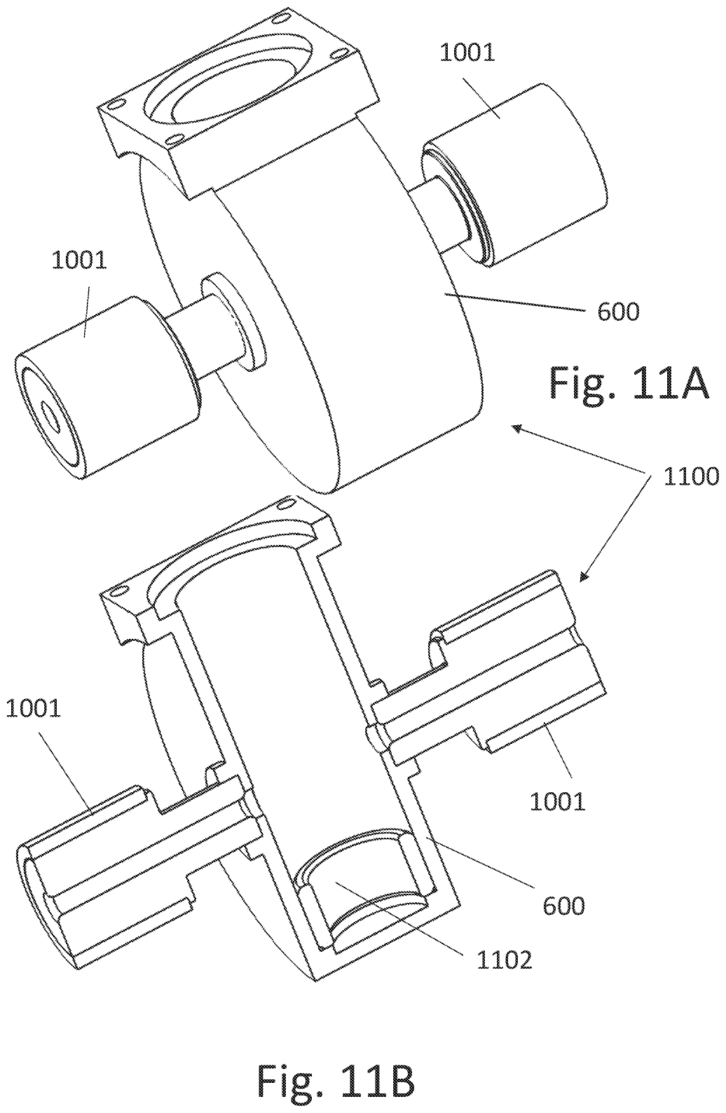

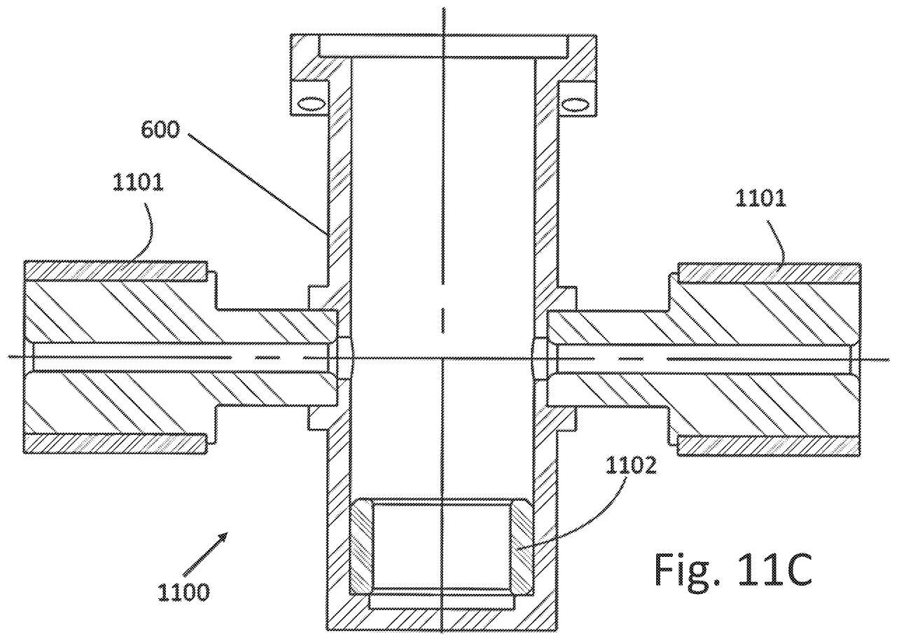

FIG. 11 A shows a 3D model of a compressor base assembly 1100, according to some embodiments. FIGS. 11B and 11C show 3D model and schematic cross sections, respectively, of the compressor base assembly. Compressor base assembly 1100 may include housing 600, piston liners 1101 and axially polarized magnet ring 1102 which is the stationary part of the magnet spring supporting the displacer assembly. Piston liners 1101 and axially polarized magnet ring 1102 may be connected to housing 600 with adhesives. Piston liners 1101 may be tightly fit to the cylindrical extruded bosses 602 of housing 600 and connected by a low outgassing adhesive, such as Loctite 638 or similar. Piston liners 1101 may be configured to be stationary and may be made of the same material as cylinder liner 1001 of moving cylinder assembly 1000. Moving assemblies 1000 may be arranged slidably upon piston liners 1101. The outer diameter of piston liners 1001 and inner diameter of cylinder liner 1001 may be matched with a 10 μm radial gap, thereby forming close clearance seals.

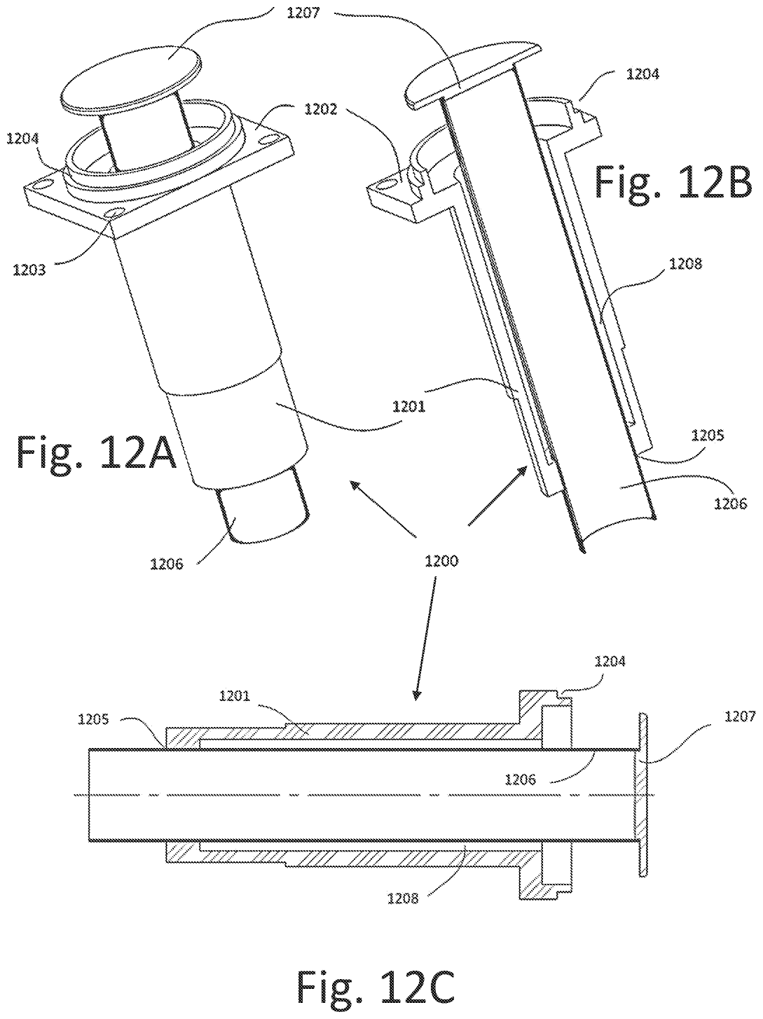

FIG. 12A shows a 3D model of a cold finger 1200, according to some embodiments of the invention. FIGS. 12B and 12C show 3D and schematic cross sections, respectively, of the cold finger.

Cold finger 1200 may include a tubular cold finger base 1201 having a connection flange 1202 with threaded holes 1203. Cold finger 1200 may include provisions 1204 and/or 1205 for mounting a tubular Dewar shroud such as an IDDA (not shown) at one end and attaching (e.g. by laser welding) the cold finger tube 1206 at another end distal to the mounting flange end. In some embodiments, the IDDA includes a tubular Dewar shroud typically made of Kovar alloy.

Cold finger tube 1206 may be coaxial with a central bore of the cold finger base 1201, the diameter of which bore is larger than that of the cold finger tube. An air gap 1208 may be provided between the cold finger tube 1206 and the central bore of the cold finger base 1201.

A cold finger plug 1207 may be attached (e.g., by laser welding) to a cold end which is distal to the connection to the cold finger base 1201. The cold finger tube 206 is sealingly capped by the cold plug 207 at its end which is distal to the mounting flange.

In some embodiments, the cold finger base is made of stainless steel (SST 304L. 316L or similar). The cold finger tube may be a seamless tube with a wall thickness ranging between 80-110 micrometers (e.g., depending on application) extruded of cobalt-chromium-tungsten-nickel Haynes® 25 L-605 UNS R30605 alloy. The cold plug 207 may be made of Invar, which may improve a matching between coefficients of thermal contraction between the cold plug and the ceramic materials typical of substrates of a focal plane array. All three components may be connected by low heat laser welding.

Stationary and axially polarized magnet ring 1102 may be affixed by adhesive coaxially at the distal end from the cold plug.

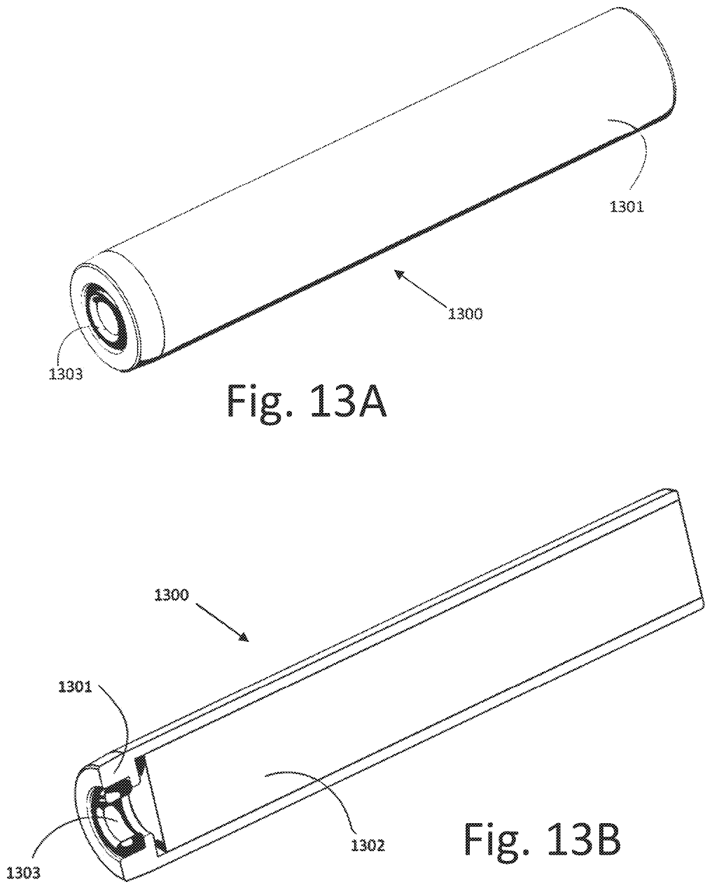

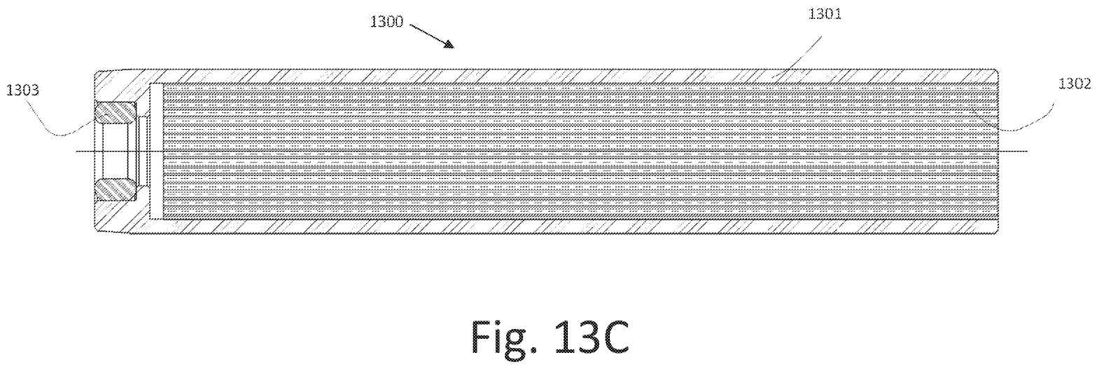

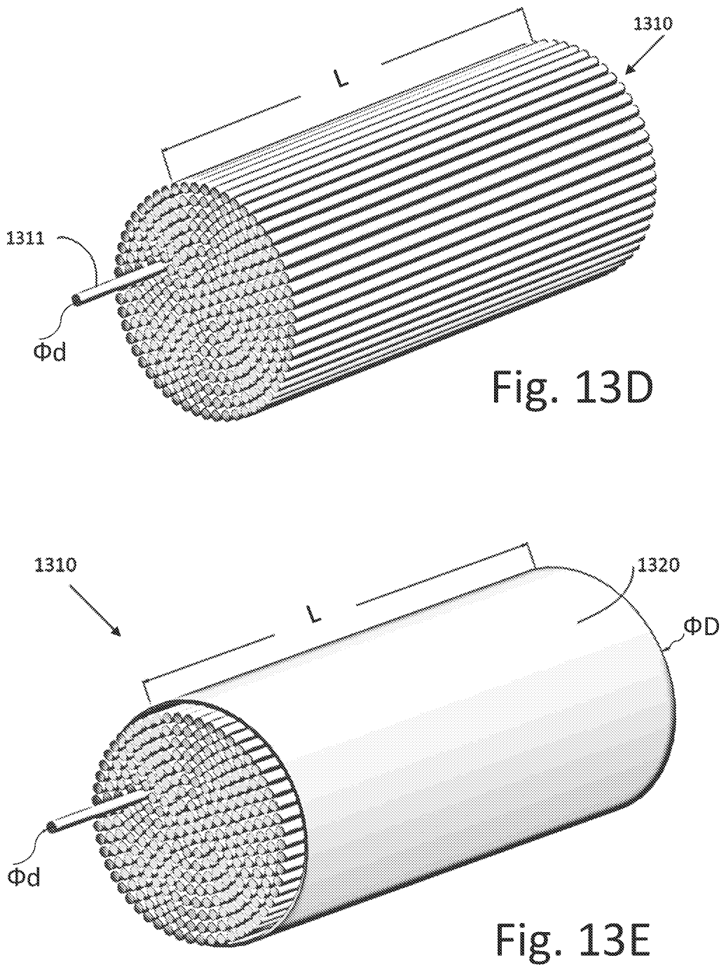

FIG. 13A shows a 3D model of a displacer assembly 1300, according to some embodiments of the invention. FIGS. 13B and 13C show 3D model and schematic cross sections, respectively, of the displacer assembly. Displacer assembly 1300 may include a displacer tube (e.g., tubular cartridge) 1301. In some embodiments, displacer tube 1301 is made of a low heat conductive plastic such as Polyetheretherketone (PEEK). Displacer assembly 1300 may include a so-called plungerless displacer driven by pneumatic resistance, in contrast to a displacer driven pneumatically by a differential piston (plunger).

Displacer assembly 1300 may include (e.g., displacer tube 1301 may be filled with) a regenerative heat exchanger material (e.g., regenerator material) 1302. In some embodiments, the regenerator material 1302 includes a cylindrical matrix/bundle of synthetic filaments parallel to the second axis 6002.

FIGS. 13D and 13E show 3D model cross sections of a regenerator material, according to some embodiments of the invention. For example, a regenerator matrix may be of a parallel wire type in the form of a cylindrical bundle 1310 of diameter D of parallel synthetic filaments 1311 of diameter d and length L equaling the depth of the bore of the regenerator tube. The filaments, wires, strands, or fibers (these terms being used interchangeably herein) may be packed into, and oriented parallel to a longitudinal axis of the displacer tube and wrapped in a thin synthetic film 1320, thus forming a regenerator cartridge that may be easily press fit inserted into the axial bore of the displacer tube. The regenerator material may include, for example, polyester and/or nylon. Use of polymer filaments may enable simple and repeatable construction of a regenerative heat exchanger that is both lightweight and inexpensive. In some examples, for a parallel strand regenerative heat exchanger having an outer diameter in the range of 3 mm to 10 mm and a length in the range of 20 mm to 50 mm, a suitable diameter of each parallel strand may be in the range of 5 μm to 15 μm, with a porosity factor in the range of 60% to 80%. Such a regenerator material may be found in a mass production of fiber nibs for marker pens worldwide and may be obtained, for example, from Teibow CO., Ltd, Japan (https://teibow.co.jp/english/).

Displacer assembly 1300 may include a movable component of a magnet spring configured to restore the displacer assembly to an equilibrium position. For example, displacer assembly 1300 may include movable magnet ring 1303 featuring axial polarization opposite to the polarization direction of stationary magnet ring 1102 (Shown in FIGS. 11B and 11C). An outer diameter of movable magnet ring 1303 may be so as to fit inside an inner diameter of displacer tube 1301. The outer diameter of movable magnet ring 1303 may be smaller than an inner diameter of stationary magnet ring 1102 such that movable magnet ring 1303 can move slidably within stationary magnet ring 1102. The opposite polarization of magnetic rings 1303 and 1102 may result in a stable position of static equilibrium for displacer assembly 1300. When perturbed, the displacer may be resonantly driven within the second bore. The two magnet rings may be positioned width symmetrically with respect to each other due to the magnetic spring effect. The movable axially polarized magnet ring 1303 may be coaxially affixed by adhesive at a nest (e.g. the place where one part is arranged to be nested inside another part) provided at the warm side of displacer assembly 1300.

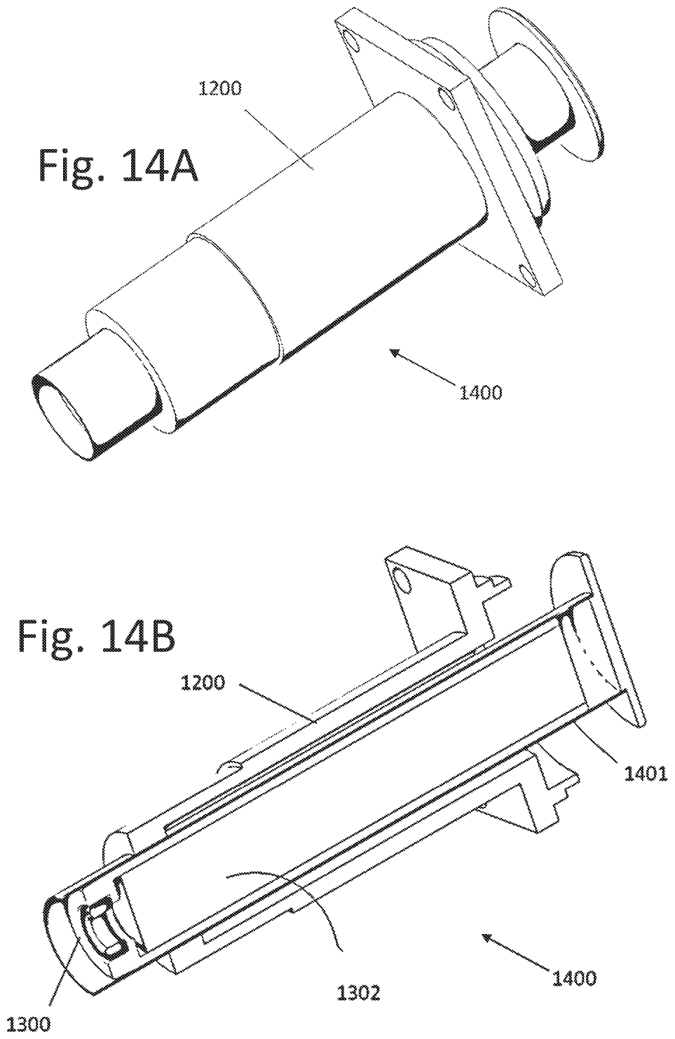

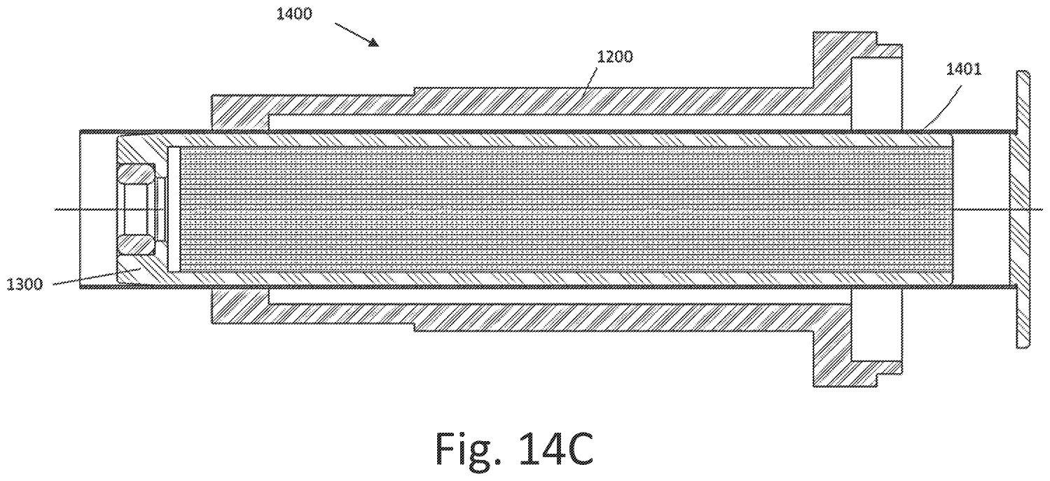

FIG. 14A shows a 3D model of an expander assembly 1400 (e.g., pneumatic expander assembly), according to some embodiments of the invention. FIGS. 14B and 14C show 3D model and schematic cross sections, respectively, of expander assembly 1400. Expander assembly 1400 may include cold finger 1200 (see FIGS. 12A-C) and displacer assembly 1300 (see FIGS. 13A-E). Displacer assembly 1300 may be arranged slidably inside cold finger tube 1206 of cold finger 1200. An air gap 1401 of typically 40-50 micrometers may exist between displacer assembly 1300 and a bore of the cold finger tube, thus forming close clearance seals preventing pneumatic communication between cold and warm sides of displacer other than through the porous regenerator material 1302. In expander assembly 1400, cold finger 1200 may be configured to remain stationary whilst displacer assembly 1300 may be configured to be movable. For example, the displacer may be configured to be driven within the second bore collinearly with the second axis by a pressure wave generated by the dual-piston compressor assembly (e.g., moving assemblies 1000).

Expander assembly 1400 may be placed inside the second bore of housing 600 coaxially with the second axis. The second bore of housing 600 may be configured to receive expander assembly 1400 for this purpose. Expander assembly 1400 may be connected sealingly to housing 600 using flanges 603 and 1202.

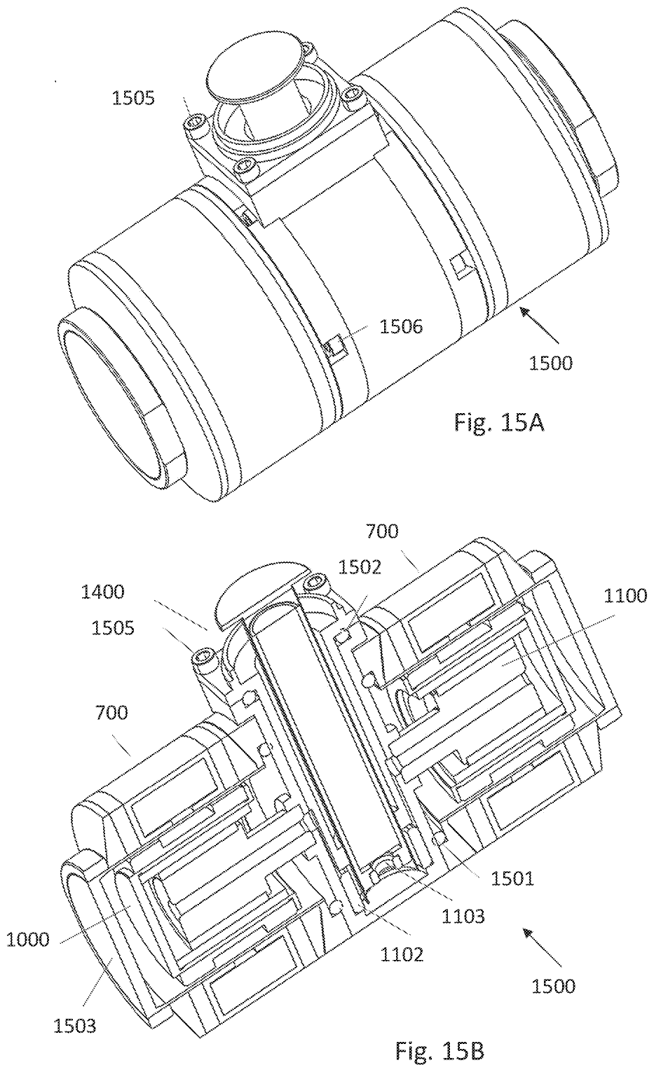

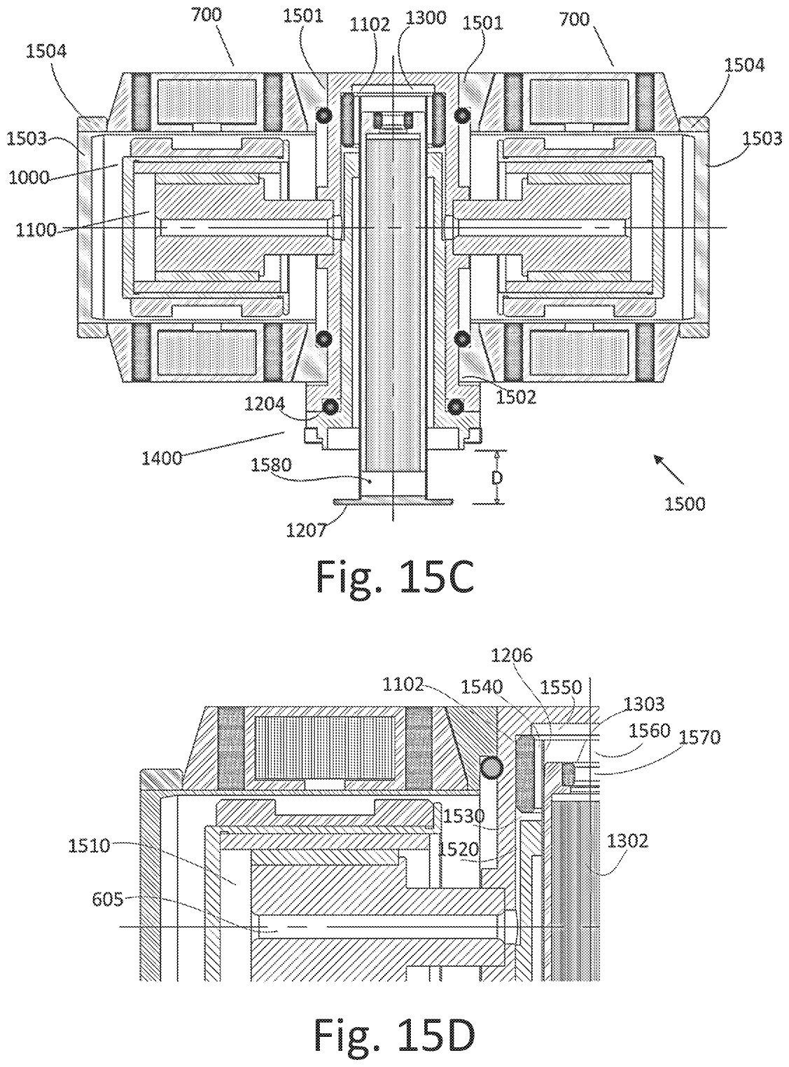

FIG. 15A shows a 3D model of a Stirling type cryogenic refrigerator 1500, according to some embodiments of the invention. FIGS. 15B and 15C show 3D and schematic cross sections, respectively, of the Stirling type cryogenic refrigerator 1500 in accordance with embodiments of the invention. FIG. 15D shows a close up schematic cross section of the Stirling type cryogenic refrigerator 1500 in accordance with embodiments of the invention. As discussed, a Stirling type cryogenic refrigerator in accordance with embodiments of the invention has the expander assembly concealed within the housing.

In some embodiments, Stirling type cryogenic refrigerator 1500 may contain a gaseous working agent, such as e.g., helium, nitrogen, or another suitable, usually inert, gas.

Moving cylinder assemblies 1000 of FIGS. 10A-B may be arranged slidably upon piston liners 1101 of compressor base assembly 1100. A radial gap of typically 10-14 micrometers may exist between the cylinder and the piston liners, thus forming close clearance seals.

Tubular capped rear covers 1503 may be attached sealingly to compressor base assembly 1100 using screws 1505 and seals 1501. Tubular capped rear covers 1503 may separate a pressurized compressor interior from the surroundings.

Actuator stators 700 of FIGS. 7A-B may be affixed coaxially upon rear covers 1503 and secured, for example using nuts 1504. Moving assemblies 1000 may be axially width centered relative to the actuator stators 700. Because of the effect of the magnet spring existing between stator 700 and mover 800, moving assembly 1000 is axially centered with respect to the stator assembly. Stator 700 and mover 800 (as part of moving assembly 1000) form the moving iron actuator 900 of FIGS. 9A-B.

Expander assembly 1400 of FIGS. 14A-C (including cold finger 1200 of FIGS. 12A-12C and displacer assembly 1300 of FIGS. 13A-E) may be arranged coaxially inside the second bore of housing 600 and sealingly secured using screws/nuts 1505 and seal 1502.

Moving magnet ring 1303 may be width centered relative to coaxial stationary magnet ring 1102.

Application of an alternating current (AC current) to the oppositely wound driving coils 701 (see, e.g., FIG. 7C) may generate opposite net AC forces applied to the movers 800 which are part of the moving assemblies 1000. This may result in opposite reciprocation of the moving assemblies 1000 and cyclic compression/expansion of a working agent in compression chambers 1510, which are in pneumatic communication with the warm chamber 1560 of expander through the pneumatic path formed by the conduits 605, gaps 1520 and 1540, and circular gap 1530, provided between the bore 604 in the cryocooler housing 600 and cold finger base 1200, the circular gap provided between static magnet 1102 and cold finger tube 1206 and through the cavity 1550.

From the warm chamber 1560, the working gas is in direct pneumatic communication with the expansion chamber 1580 through the circular hole 1570 of the moving magnet ring 1303 and regenerator matrix 1302. The cyclic flow of the working agent through the regenerator matrix may result in a drag force applied to the displacer assembly 1300, which is supported from the stationary base by a magnetic spring formed by the coaxial and oppositely polarized stationary magnet ring 1102 and moving magnet ring 1303. The spring rate of the resulting magnetic spring is predesigned with respect to the mass of displacer assembly and the driving frequency so as to provide resonant operation of the displacer as needed for an improved refrigeration effect.

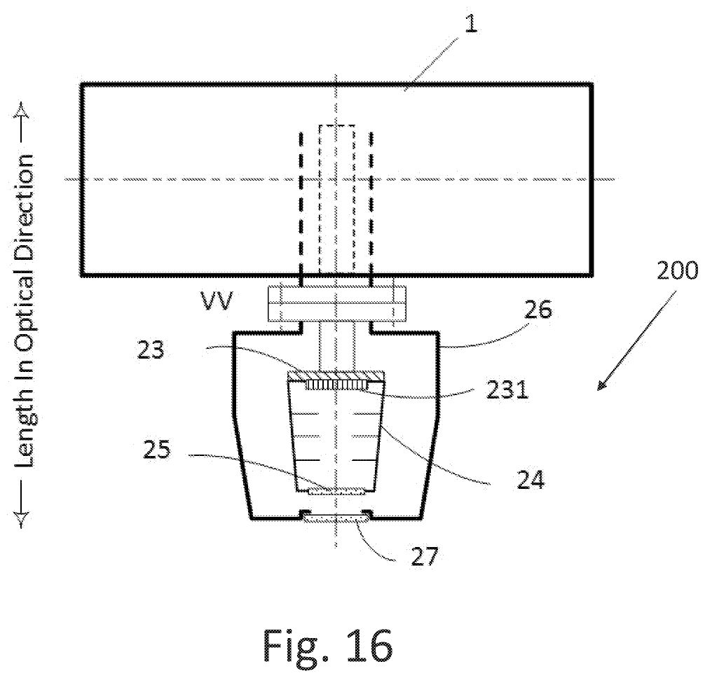

The distance D between the stepped mounting provision 1204 and the end of the cold finger plug 1207 is minimized as needed for construction of the Dewar envelope. Thus, the overall optical length and void volume may be minimized, as shown in FIG. 16.

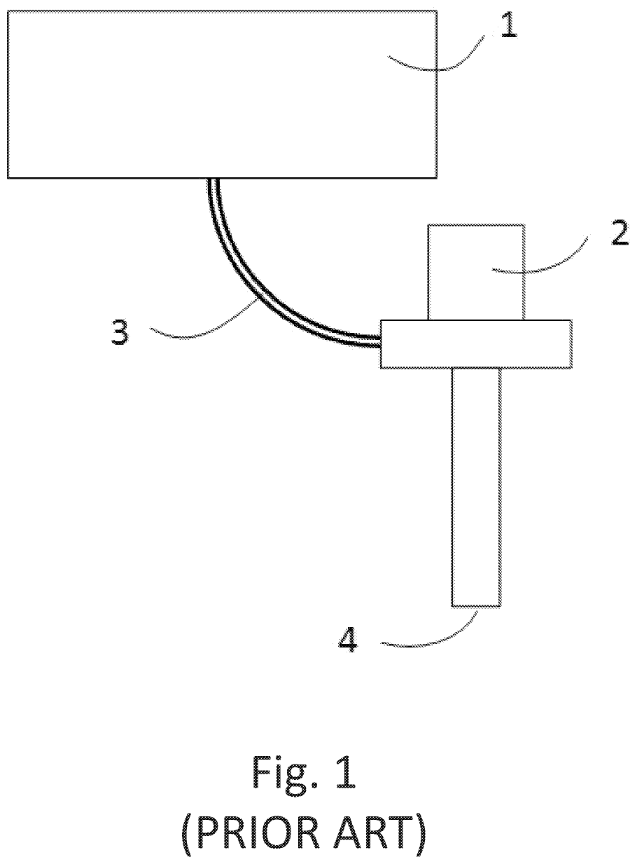

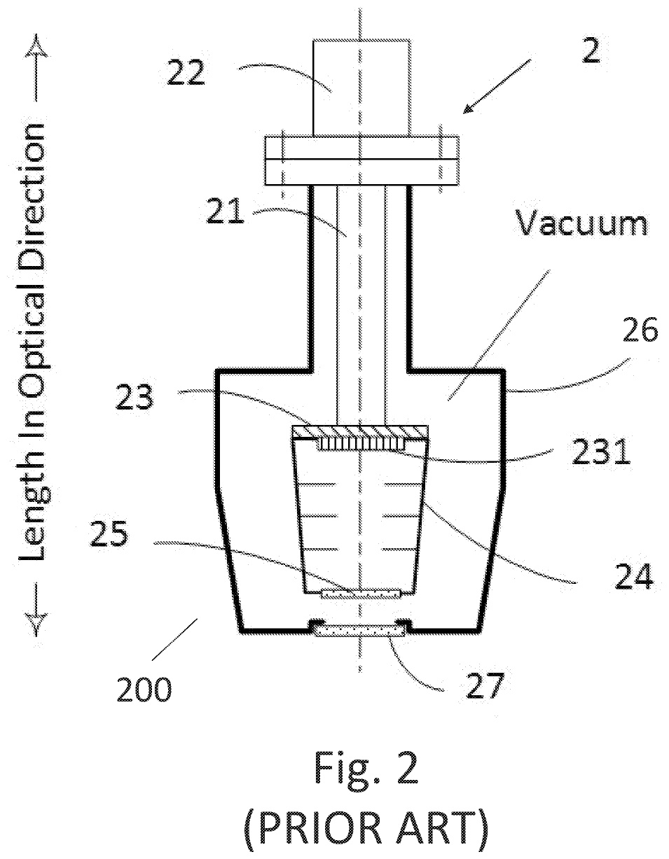

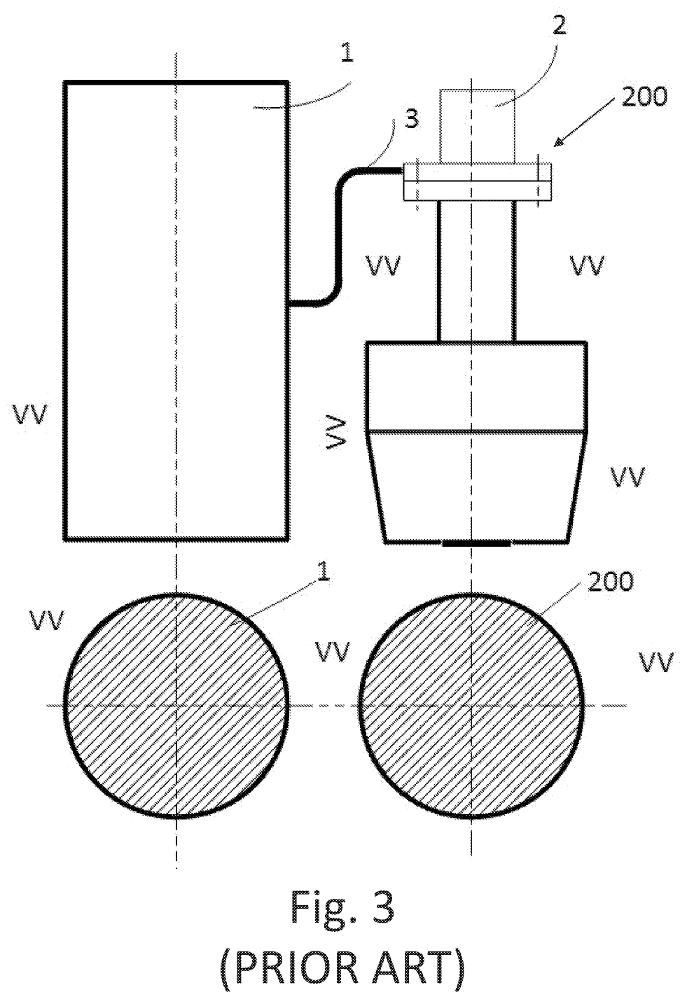

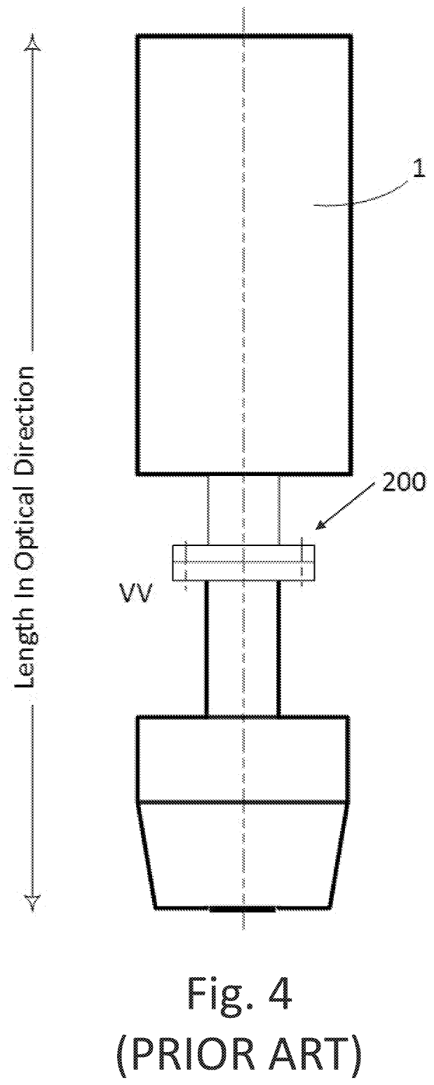

FIG. 16 schematically shows a Dewar detector assembly integrated with the Stirling type cryogenic refrigerator, according to some embodiments of the invention. Reference signs are the same as in FIGS. 1 and 2.

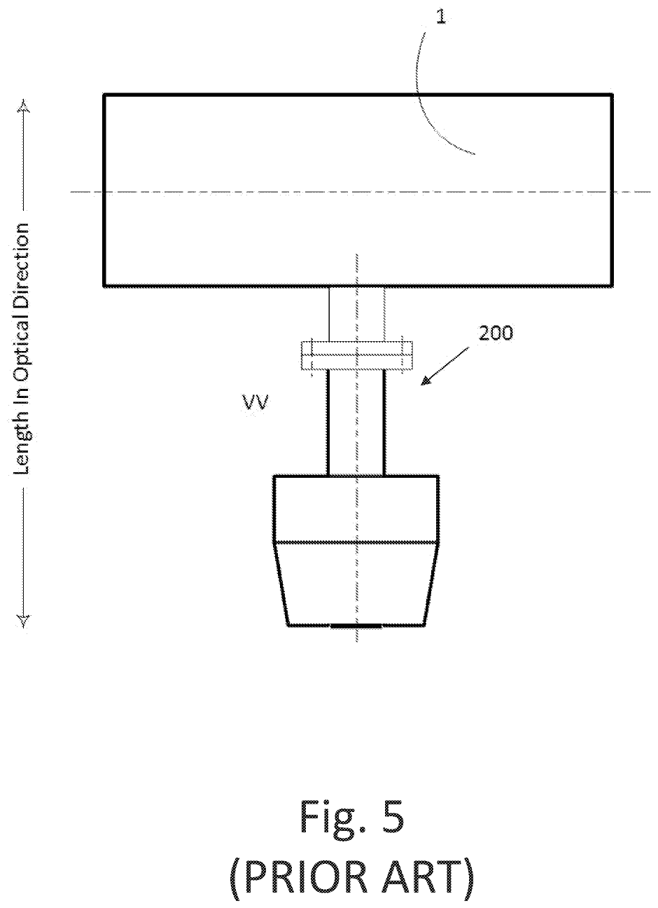

The compressor unit 1 and Dewar detector assembly 200 are integrated orthogonally whereupon most of the expander is concealed inside the cryocooler base (shown schematically by dashed lines) in accordance with embodiments of the invention (see, for example. FIGS. 15A-C). The result is a shorter length in the optical direction (as compared to, for example, the topology shown in FIG. 5) and smaller void volume. As discussed, this may benefit compact mounting solutions, such as when mounting an infrared imager to an aerial platform such as drone.

According to one or more embodiments, there is provided a system for maintaining a temperature of a focal plane array. The system may include a cryogenic refrigerator, such as Stirling type cryogenic refrigerator 1500. The Stirling type cryogenic refrigerator may include: a housing (such as housing 600) which includes a first bore along a first axis, and a second bore intersecting the first bore along a second axis orthogonal to the first axis; a dual-piston compressor assembly including two sub-compressor assemblies (such as moving assemblies 1000), each sub compressor-assembly including a piston configured to be driven collinearly with the first axis, each sub-compressor assembly configured to be in pneumatic communication with a respective end of the first bore; and a pneumatic expander (such as expander assembly 1400) colinear with the second axis and located inside the second bore, the pneumatic expander including a cold finger, and a displacer, the displacer including a regenerator material.

The system may also include an imaging system. The imaging system may include a focal plane array. The focal plane array may be configured to be maintained at a predefined temperature by a thermal connection to the cold finger of the Stirling type cryogenic refrigerator.

For example, the cold finger may include a cold finger plug which may be connected to a substrate, such as a ceramic substrate, of the focal plane array.

In some embodiments, an optical path of the imaging system is orthogonal to a driving axis of the dual-piston compressor assembly (e.g. the first axis) and parallel (or collinear) to an axis of the pneumatic expander (e.g. the second axis).

In some embodiments, the imaging system is a thermal imaging system, such as an infrared imaging system.

In some embodiments, the focal plane array is housed in an integrated Dewar detector assembly (IDDA). The Stirling type cryogenic refrigerator may be configured to be connected to the IDDA (e.g., via mounting provision 1204 shown in FIGS. 12A-C).

In some embodiments, the system (that is, the Stirling type cryogenic refrigerator and imaging system) are mounted on a movable platform. The movable platform may be, for example, a land-based platform such as a car, an aerial platform such as an unmanned aerial vehicle (UAV)/drone, an amphibious platform, an aquatic platform, or any other type of directly or remotely controlled platform capable of movement.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

### LIST OF REFERENCE NUMERALS

1 Compressor unit
2 Expander unit
3 Transfer line
4 Cold end
21 Cold finger
22 Rear cover
23 Substrate
231 Focal plane array (FPA)
24 Cold shield
25 Cold filter
26 Evacuated envelope
27 Infrared window
200 Integrated dear detector assembly (IDDA)
VV Void volume
600 Housing
601 Cylindrical central part
602 Cylindrical extruded bosses
603 Connection flange
6031 Threaded holes
604 Second bore
605 First bore/conduits
6001 First axis
6002 Second axis
700 Stator
701 Driving coil
702 Back iron
7031 Permanent magnet ring
7032 Permanent magnet ring
704 Side pole
705 Air gap
800 Mover
900 Linear moving iron actuator
1000 Moving cylinder assembly
1001 Cylinder liner
1002 Nonmagnetic capped cylinder
1100 Compressor base assembly
1101 Piston liners
1102 Axially polarized stationary magnet ring
1200 Cold finger
1201 Tubular cold finger base
1202 Connection flange
1203 Threaded holes
1204 Mounting provision
1205 Mounting provision
1206 Cold finger tube
1207 Cold finger plug
1208 Air gap
1300 Displacer assembly
1301 Displacer tube
1302 Regenerator material
1303 axially polarized movable magnet ring
1310 Cylindrical bundle of synthetic filaments
1311 Synthetic filament
1320 Thin synthetic film
1400 Expander assembly
1401 Air gap
1500 Stirling type cryogenic refrigerator according to embodiments of the invention
1501 Seal
1502 Seal
1503 Capped rear cover
1504 Nut
1505 screw
1506 screw
1510 Compression chamber
1520 gap of pneumatic path
1530 Circular gap
1540 gap of pneumatic path
1550 Cavity
1560 Warm chamber
1570 Circular hole in axially polarized movable magnet ring 1303
1580 Expansion chamber

1. A Stirling type cryogenic refrigerator device comprising:
a dual-piston compressor and a pneumatic expander, wherein some of the pneumatic expander is concealed within the body of the dual-piston compressor.

2. The device of claim 1, wherein most of the pneumatic expander is concealed within the body of the dual-piston compressor.

3. The device of claim 1, wherein the dual-piston compressor comprises two sub-compressor assemblies, each having a compression space in a pneumatic communication with the warm space of the pneumatic expander.

4. The device of claim 1, wherein each of the two sub-compressor assemblies of the dual-piston compressor comprises a piston, wherein the pistons of the two sub-compressor assemblies are configured to be driven collinearly with respect to a first axis.

5. The device of claim 4, wherein the pistons of the two sub-compressor assemblies are configured to be driven oppositely.

6. The device of claim 4, wherein the pistons of the two sub-compressor assemblies are configured to be driven by an electromagnetic actuator.

7. The device of claim 6, wherein the electromagnetic actuator is one of a moving coil type, a moving magnet type, or a moving iron type.

8. The device of claim 4, wherein the pneumatic expander is located within a bore in a housing of the dual-piston compressor, the bore extending along a second axis which is orthogonal to the first axis.

9. The device of claim 8, wherein the pneumatic expander comprises a spring assisted displacer configured to be driven within the bore collinearly with the second axis by a pressure wave generated by the dual-piston compressor assembly.

10. The device of claim 9, wherein the spring is a magnetic spring.

11. The device of claim 10, wherein the magnetic spring comprises an axially and oppositely polarized coaxial width centered magnetic rings.

12. The device of claim 8, wherein the pneumatic expander comprises a regenerator material formed of a cylindrical bundle of synthetic filaments parallel to the second axis.

13. The device of claim 1 comprising a gaseous working agent.

14. A system comprising:
a Stirling type cryogenic refrigerator device comprising:
a dual-piston compressor and a pneumatic expander, wherein some of the pneumatic expander is concealed within the body of the dual-piston compressor; and
an imaging system comprising a focal plane array,
wherein the focal plane array is configured to be maintained at a predefined temperature by a thermal connection to the Stirling type cryogenic refrigerator device.

15. The system of claim 14, wherein an optical path of the imaging system is orthogonal to a driving axis of the dual-piston compressor and parallel to a driving axis of the pneumatic expander.

16. The system of claim 14, wherein the imaging system is a thermal imaging system.

17. The system of claim 14, wherein the focal plane array is housed in an integrated Dewar detector assembly (IDDA).

18. The system of claim 14, wherein the system is mounted on a movable platform.

19. A housing for a Stirling type cryogenic refrigerator, the housing comprising a first bore along a first axis, and a second bore intersecting the first bore along a second axis orthogonal to the first axis,
wherein each end of the first bore is configured to receive a sub-compressor assembly of a dual-piston compressor assembly of the Stirling type cryogenic refrigerator, and
wherein the second bore is configured to receive a pneumatic expander of the Stirling type cryogenic refrigerator.

20. The housing of claim 19, wherein the second bore is deep enough to accommodate most of the length of the pneumatic expander.
